(19) United States
(12) Patent Application Publication
(10) Pub. No.: US 2019/0055492 A1
(43) Pub. Date: Feb. 21, 2019

(54) AGENT FOR REDUCING ACID VALUE OF USED COOKING OIL AND METHOD FOR REGENERATING USED COOKING OIL USING SAME

(71) Applicant: KYOWA CHEMICAL INDUSTRY CO., LTD., Takamatsu-shi, Kagawa (JP)

(72) Inventor: Harumi Takabatake, Sakaide-shi (JP)

(73) Assignee: KYOWA CHEMICAL INDUSTRY CO., LTD., Takamatsu-shi, Kagawa (JP)

(21) Appl. No.: 16/071,541

(22) PCT Filed: Feb. 25, 2016
(86) PCT No.: PCT/JP2016/055552

§ 371 Date: Oct. 24, 2018

(30) Foreign Application Priority Data
Jan. 25, 2016 (JP) 2016-011798

(51) Int. Cl. C11B 3/10; A23D 9/04; A23L 5/20

(52) U.S. Cl. CPC C11B 3/10; A23V 2002/00; A23L 5/273; A23D 9/04

(57) ABSTRACT

An agent for reduction of the acid value of used cooking oil that exerts the effects required for a regeneration agent for used cooking oil, and a regeneration treatment method for used cooking oil using it are provided. The agent is an agent for reduction of the acid value of used cooking oil containing a hydrotalcite-related compound as an effective component, wherein the agent has a decoloration capacity that reduces the acid value by 70% or more. The agent also has a deacidification capacity that reduces yellowness due to deterioration by 15%. The hydrotalcite-related compound is a hydrotalcite-related compound calcined at 150 to 400° C. The hydrotalcite-related compound is a hydrotalcite-related compound granulated to have an average particle size of 50 to 200 μm.

### TECHNICAL FIELD

The present invention relates to an agent for reduction of the acid value of used cooking oil, comprising a hydrotalcite-related compound as an effective component, and a regeneration treatment method for used cooking oil using the agent.

### BACKGROUND ART

It is widely known that cooking oil used for cooking fried foods at home or in the food service industry or food manufacturing industry undergoes hydrolysis of oil and fat by heat and water contained in materials of the fried foods, causing production of free fatty acid, which then undergoes thermal oxidation to produce peroxides, thereby causing deterioration of the cooking oil. Used cooking oil deteriorated due to cooking of a fried food exhibits a color change to brown, produces a bad smell, and has an increased viscosity. When the used cooking oil is repeatedly used, flavor of the fried food is lost, and a fried food with an unfavorable quality is produced. Thus, since degeneration and deterioration of cooking oil proceed every time when it is used, cooking oil is usually discarded and replaced periodically. On the other hand, in recent years, reuse of used cooking oil after regeneration treatment is becoming common from the viewpoint of reduction of the environmental load and suppression of the cooking cost.

For such regeneration treatment of cooking oil, calcium oxide, calcium hydroxide, calcium silicate, magnesium oxide, magnesium hydroxide, and magnesium silicate are known as deacidifying agents. Silicon oxide, acid clay, activated clay, aluminum silicate, aluminum hydroxide, and activated carbon are known as decoloring agents.

The reaction between the deacidifying agent and the free fatty acid in the cooking oil is a reaction between an acid and a solid base. In this case, as the specific surface area of the deacidifying agent increases, the contact area with the fatty acid increases, which is expected to be advantageous from the viewpoint of the deacidification rate and the deacidification capacity. PTL 1 and PTL 2 describe an idea wherein an inorganic porous body having a large specific surface area such as silicon oxide is immersed in an aqueous magnesium solution or an aqueous calcium solution, and then dried, followed performing calcination to increase the specific surface area of the deacidifying agent. In PTL 3, magnesium hydroxide is used to perform deacidification treatment of cooking oil, wherein the magnesium hydroxide is a high-purity magnesium hydroxide itself which is generally commercially available.

PTL 4 proposes a deacidifying agent for cooking oil, selected from the group consisting of magnesium oxide, calcium oxide, magnesium carbonate, calcium carbonate, calcium silicate, magnesium silicate, calcium hydroxide, magnesium hydroxide, aluminum hydroxide, synthetic magnesium phyllosilicate, silica, magnesia, silicon dioxide, and activated clay, characterized in that the agent is granulated to a particle size of 50 to 200 μm, wherein the agent has an advantage in the filtration rate because of its large particle size.

PTL 5 proposes a silica-magnesia-based preparation to be used for purification treatment of cooking oil, comprising a silica component and a magnesia component at a ratio at which the weight ratio (R) represented by the equation R=Sw/Mw (wherein Sw is the content of the silica component in terms of SiO₂, and Mw is the content of the magnesia component in terms of MgO) is within the range of 0.1≤R≤1.9, characterized in that at least part of the silica component and the magnesia component form a microlayer structure in which a silica component layer and a magnesia component layer are joined together in parallel, and that the preparation has a fatty acid adsorption capacity of 0.16 mmol/g or more.

PTL 6 proposes a filter agent for regeneration of cooking oil using a composition comprising a single, or a combination of a plurality of, inorganic filler(s) and/or organic filler(s), having an amount of carbon dioxide adsorption of 300 μmol/g or more as measured by the thermal desorption method, an amount of ammonia adsorption of 500 μmol/g or more, and a BET specific surface area of 150 m²/g or more; and a filter agent for regeneration of cooking oil, wherein the inorganic filler(s) is/are a single filler or a combination of two or more fillers selected from dry mixtures containing one of, or a combination of two or more of, silica, silica-magnesia, and hydrotalcite-related compounds, wet mixtures containing two or more of these, wet mixtures of activated carbon and silica-magnesia, and wet mixtures of activated carbon and hydrotalcite, and wherein the organic filler(s) is/are a dietary fiber(s). Since hydrotalcite has a high carbon dioxide adsorption capacity, it is very useful. However, since hydrotalcite has only a small amount of ammonia adsorption, it is rather insufficient for improvement of hue although it contributes to improvement of the acid value. In view of this, it has been proposed that, by preparing a wet treatment product by hot-water mixing of silica or silica gel having a large specific surface area with hydrotalcite, a filter agent having a better balance than their simple intermixture can be obtained.

### CITATION LIST

### Patent Literature

PTL 1: JP-A-2006-241245

PTL 2: JP-A-2006-334221

PTL 3: JP-A-2010-163569

PTL 4: JP-A-2001-335793

PTL 5: JP-A-2005-8675

PTL 6: JP-A-2012-251095

PTL 7: U.S. Pat. No. 3,539,306

### Non Patent Literature

NPL 1: Seiichi Kondo et al., Kagaku Seminar 16, Kyuchaku no Kagaku, Maruzen, pp. 52-54, pp. 79-80.

### SUMMARY OF INVENTION

### Technical Problem

Since a deacidifying agent synthesized by the method of PTL 1 or PTL 2 contains only a small amount of solid base with respect the entire agent, the theoretical amount of deacidification per unit weight is small. PTL 3 merely describes that the purity of the magnesium hydroxide is 97% by weight or more, and this corresponds to a high-purity magnesium hydroxide itself which is generally commercially available. In PTL 4, there is no description of effects except for the advantage in the filtration rate due to the large particle size. PTL 5 is a significant technique from the viewpoint of suppressing production of a metal soap by control of the strong basicity of magnesium oxide, but it is difficult for this technique to reduce the acid value of deteriorated cooking oil whose acid value has increased by repeated use. Although PTL 6 describes that the wet treatment product is not a simple powder mixture system, and that a certain chemical or physical change occurs between the hydrotalcite interlayer of and the silica, there is no description at all that demonstrates this fact.

The effects required for a regeneration agent for used cooking oil can be roughly divided into two categories. One of these is a deacidification effect which enables conversion and removing of free fatty acid produced by deterioration into a compound insoluble in oil and fat, and the other is a decoloration effect which enables adsorption removal of colored substances from used cooking oil whose color has changed to brown due to deterioration, to restore a color that is close to that of unused oil.

An object of the invention is to provide an agent for reduction of the acid value of used cooking oil that exerts the effects required for a regeneration agent for used cooking oil, and a regeneration treatment method for used cooking oil using it. More preferably, an object of the invention is to provide a cooking oil regeneration agent having both an excellent deacidification effect and an excellent decoloration effect, and a regeneration treatment method for used cooking oil using it.

### Solution to Problem

In order to solve the problems, the present inventors intensively studied to discover a deacidification effect wherein a high acidic-substance adsorption capacity of a Mg—Al-based hydrotalcite-based compound can be used for adsorption removal of free fatty acid in used cooking oil, and to discover that, by supporting of silica in the interlayer or on the surface of a Mg—Al-based hydrotalcite-based compound, the BET specific surface area and the pore specific surface area can be increased, and the deacidification effect and the decoloration effect can be enhanced at the same time, thereby completing the invention.

The invention relates to the agent for reduction of the acid value of used cooking oil according to the following (1) to (11).

(1) An agent for reduction of the acid value of used cooking oil, the agent comprising a hydrotalcite-related compound as an effective component, wherein the agent has a deacidification capacity that reduces the acid value by 70% or more.

(2) The agent for reduction of the acid value of used cooking oil according to (1), wherein the agent has a decoloration capacity that reduces yellowness due to deterioration by 15%.

(3) The agent for reduction of the acid value of used cooking oil according to (1) or (2), wherein the hydrotalcite-related compound is a hydrotalcite-related compound calcined at 150 to 400° C.

(4) The agent for reduction of the acid value of used cooking oil according to any one of (1) to (3), wherein the hydrotalcite-related compound is a hydrotalcite-related compound granulated to have an average particle size of 50 to 200 μm.

(5) The agent for reduction of the acid value of used cooking oil according to any one of (1) to (4), wherein the hydrotalcite-related compound is a Mg—Al-based hydrotalcite-based compound and/or a silica-supported Mg—Al-based hydrotalcite-based compound.

(6) The agent for reduction of the acid value of used cooking oil according to (5), wherein the silica-supported Mg—Al-based hydrotalcite-based compound is a compound in which silica is supported in the interlayer or on the surface of a Mg—Al-based hydrotalcite-based compound.

(7) The agent for reduction of the acid value of used cooking oil according to (5) or (6), wherein the Mg—Al-based hydrotalcite is represented by the following Formula (1):

Mg₁₋ₓAlₓ(OH)₂(Aⁿ⁻)_{x/n}.yH₂O (1)

[Mg₁₋ₓAlₓ(OH)₂]^{x+}[(Aⁿ⁻)_{x/n}.yH₂O]

(wherein in the formula, Aⁿ⁻ represents an anion selected from the group consisting of CO₃²⁻, SO₄²⁻, NO₃⁻, Cl⁻, and OH⁻; n represents 1 or 2; and x and y satisfy the inequality 0.18≤x≤0.44 and the inequality 0≤y<1),

and the silica-supported Mg—Al-based hydrotalcite-based compound is represented by the following Formula (2):

Mg₁₋ₓAlₓ(OH)₂(A₁ⁿ⁻)ₐ(A₂^{m-})_{b}.yH₂O (2)

[Mg₁₋ₓAlₓ(OH)₂]^{x+}[(A₁ⁿ⁻)ₐ(A₂^{m-})_{b}.yH₂O]

(wherein in the formula, A₁ⁿ⁻ represents an n-valent silicate anion, wherein the n-valent silicate anion is an anion selected from the group consisting of SiO₃²⁻, HSiO₃⁻, Si₂O₅²⁻, and HSi₂O₅⁻; A₂^{m-} represents an anion selected from the group consisting of CO₃²⁻, SO₄²⁻, NO₃⁻, Cl⁻, and OH⁻; x and y satisfy the inequality 0.18≤x≤0.44 and the inequality 0≤y<2; and a and b satisfy the inequality 0.28≤na+mb≤0.4).

(8) The agent for reduction of the acid value of used cooking oil according to any one of (5) to (7), wherein the silica-supported Mg—Al-based hydrotalcite-based compound has a specific surface area of 150 m²/g or more according to the BET method, a total specific surface area of 200 m²/g or more according to the t-plot method, and a pore specific surface area of 140 m²/g or more according to the t-plot method, wherein the pore specific surface area according to the t-plot method accounts for 70% or more of the total specific surface area.

(9) The cooking oil regeneration agent according to (8), wherein the silica-supported hydrotalcite-based compound has a specific surface area of 200 m²/g or more according to the BET method, a total specific surface area of 250 m²/g or more according to the t-plot method, and a pore specific surface area of 180 m²/g or more according to the t-plot method, wherein the pore specific surface area according to the t-plot method accounts for 70% or more of the total specific surface area.

(10) The agent for reduction of the acid value of used cooking oil according to (9), wherein the silica-supported hydrotalcite-based compound has a specific surface area of 250 m²/g or more according to the BET method, a total specific surface area of 300 m²/g or more according to the t-plot method, and a pore specific surface area of 220 m²/g or more according to the t-plot method, wherein the pore specific surface area according to the t-plot method accounts for 70% or more of the total specific surface area.

(11) The agent for reduction of the acid value of used cooking oil according to any one of (1) to (10), wherein the used cooking oil is used cooking oil heated to a temperature of 200° C. or less.

The invention also relates to the regeneration treatment method for used cooking oil according to the following (12).

(12) A regeneration treatment method for used cooking oil, characterized in that the acid value of the used cooking oil is reduced by 70% or more by bringing the agent for reduction of the acid value of used cooking oil according to any one of (1) to (10) into contact with used cooking oil heated to a temperature of 200° C. or less.

### Advantageous Effects of Invention

A cooking oil regeneration agent containing a Mg—Al-based hydrotalcite-based compound has a much higher deacidification effect than magnesium hydroxide or magnesium silicate, which has been conventionally used.

A cooking oil regeneration agent containing a silica-supported hydrotalcite-based compound in which silica is supported in the interlayer or on the surface of a Mg—Al-based hydrotalcite-based compound, which is a layered compound, has both a much higher deacidification effect and decoloration effect relative to hydrotalcite alone or a mixture of hydrotalcite and silica.

By the invention, an agent for reduction of the acid value of used cooking oil (=cooking oil regeneration agent) that exerts the effects required for a regeneration agent for used cooking oil, and a regeneration treatment method for used cooking oil using it can be provided. More preferably, an agent for reduction of the acid value of used cooking oil (=cooking oil regeneration agent) having both an excellent deacidification effect and an excellent decoloration effect, and a regeneration treatment method for used cooking oil using it can be provided.

### DESCRIPTION OF EMBODIMENTS

### Hydrotalcite-Related Compound

The hydrotalcite-related compound of the invention is a Mg—Al-based hydrotalcite-based compound and/or a silica-supported Mg—Al-based hydrotalcite-based compound.

The Mg—Al-based hydrotalcite is represented by the following Formula (1).

Mg₁₋ₓAlₓ(OH)₂(Aⁿ⁻)_{x/n}.yH₂O (1)

[Mg₁₋ₓAlₓ(OH)₂]^{x+}[(Aⁿ⁻)_{x/n}.yH₂O]

In the formula, Aⁿ⁻ represents an anion selected from the group consisting of CO₃²⁻, SO₄²⁻, NO₃⁻, Cl⁻, and OH⁻; n represents 1 or 2; and x and y satisfy the inequality 0.18≤x≤0.44 and the inequality 0≤m<1.

The silica-supported Mg—Al-based hydrotalcite-based compound is represented by the following Formula (2).

Mg₁₋ₓAlₓ(OH)₂(A₁ⁿ⁻)ₐ(A₂^{m-})_{b}.yH₂O (2)

[Mg₁₋ₓAlₓ(OH)₂]^{x+}[(A₁ⁿ⁻)ₐ(A₂^{m-})_{b}.yH₂O]

In the formula, A₁ⁿ⁻ represents an n-valent silicate anion, wherein the n-valent silicate anion is an anion selected from the group consisting of SiO₃²⁻, HSiO₃⁻, Si₂O₅²⁻, and HSi₂O₅⁻. A₂^{m-} represents an anion selected from the group consisting of CO₃²⁻, SO₄²⁻, NO₃⁻, Cl⁻, and OH⁻.

x and y satisfy the inequality 0.18≤x≤0.44 and the inequality 0≤y<2.

a and b satisfy the inequality 0.28≤na+mb≤0.4.

The method for synthesizing the Mg—Al-based hydrotalcite-based compound represented by Formula (1) is basically the same method as the method for synthesizing a known hydrotalcite particle (for example, PTL 7).

More specifically, the compound can be obtained by reaction of a magnesium compound, an aluminum compound, and, when necessary, an alkali metal hydroxide and an anion. Examples of the magnesium compound include magnesium chloride, magnesium sulfate, magnesium nitrate, magnesium acetate, magnesium hydroxide, magnesium oxide, and magnesium carbonate. Examples of the aluminum compound include aluminum chloride, aluminum sulfate, aluminum nitrate, sodium aluminate, and aluminum hydroxide. Examples of the alkali metal hydroxide include sodium hydroxide, potassium hydroxide, and lithium hydroxide. Examples of the anion include sodium carbonate, sodium hydrogen carbonate, potassium carbonate, potassium hydrogen carbonate, ammonium carbonate, sodium sulfate, potassium sulfate, ammonium sulfate, sodium nitrate, potassium nitrate, ammonium nitrate, sodium chloride, potassium chloride, ammonium chloride, sulfuric acid, nitric acid, and hydrochloric acid.

The agent for reduction of the acid value of used cooking oil has a specific surface area of 60 m²/g or more, preferably 100 m²/g or more, more preferably 200 m²/g or more according to the BET method, and a pore volume of 0.5 cm³/g or more, preferably 0.7 cm³/g or more, more preferably 0.8 cm³/g or more. As the specific surface area increases, contact with free fatty acid in the cooking oil increases, leading to production of a higher deacidification effect. As the pore volume increases, the amount of adsorption of free fatty acid in the cooking oil increases, leading to production of a higher deacidification effect.

The Mg—Al-based hydrotalcite-based compound as a precursor of the silica-supported hydrotalcite-based compound represented by Formula (2) is a Mg—Al-based hydrotalcite-based compound represented by Formula (1), and the method for synthesizing it is not limited. The method is basically the same as the method for synthesizing a known hydrotalcite particle (for example, PTL 7). For example, the compound can be obtained by mixing the magnesium chloride and the aluminum sulfate together at a ratio at which the ratio between magnesium atoms and aluminum atoms (Mg/Al) becomes 1.5 to 5, and then the sodium hydroxide and the sodium carbonate are further added thereto, followed by allowing the reaction to proceed at 0 to 40° C., preferably 5 to 35° C.

The reaction pH is 8 to 12, preferably 8 to 10. In cases where the reaction pH is 8 or less, the production rate of the Mg—Al-based hydrotalcite-based compound decreases, while in cases where the reaction pH is 12 or more, the Mg—Al-based hydrotalcite-based compound particles easily aggregate, leading to a smaller specific surface area of the particles, and poorer deacidification effect and decoloration effect.

Examples of the silica to be supported in the interlayer or on the surface of the Mg—Al-based hydrotalcite-based compound include water-soluble silicate compounds. Examples of the water-soluble silicate compounds include sodium silicate, sodium metasilicate, and sodium orthosilicate, which are commonly called water glass and represented by the general formula Na₂O.nSiO₂ (n=2 to 4), and alkali salts of silicic acid such as potassium silicate. No. 3 water glass is especially preferred.

The method for supporting silica in the interlayer or on the surface of the Mg—Al-based hydrotalcite-based compound is not limited. It may be obtained by adding the water-soluble silicate compound to a suspension of a Mg—Al-based hydrotalcite-based compound, and wet-mixing the resulting mixture at 30 to 100° C., preferably 40 to 95° C. for 1 to 8 hours, preferably 2 to 6 hours.

The amount of the silica to be supported in the interlayer or on the surface of the Mg—Al-based hydrotalcite-based compound is 0.8 to 2.2 equivalents, preferably 1.0 to 1.8 equivalents with respect to the Mg—Al-based hydrotalcite-based compound. In cases where the amount of silica is 0.8 or less, the supported amount is insufficient, leading to a small specific surface area, which results in a poor decoloration effect. In cases where the amount of silica is 2.2 or more, the excess silica that cannot be supported partially aggregate, leading to a small specific surface area, which results in a poor decoloration effect.

Since, in X-ray diffraction, the peak for the (003) face of a silica-supported hydrotalcite-based compound is shifted toward the low-angle side relative to the peak for the (003) face of a Mg—Al-based hydrotalcite-based compound, it can be seen that silicate ions are intercalated in the interlayer of the Mg—Al-based hydrotalcite-based compound.

The agent for reduction of the acid value of used cooking oil has a specific surface area of 150 m²/g or more, preferably 200 m²/g or more, more preferably 250 m²/g or more according to the BET method, a total specific surface area of 200 m²/g or more, preferably 250 m²/g or more, more preferably 300 m²/g or more according to the t-plot method, and a pore specific surface area of 140 m²/g or more, preferably 180 m²/g or more, more preferably 200 m²/g or more according to the t-plot method. As these specific surface areas increase, contact with free fatty acid in the cooking oil increases, leading to production of a higher deacidification effect. Similarly, as the specific surface areas increase, contact with colored substances in the used cooking oil increases, leading to production of a higher decoloration effect.

The t-plot method is a known technique, and described in, for example, NPL 1 in detail. In the t-plot method, a reference isotherm prepared by plotting the thickness of the adsorbed layer (t) against the relative pressure (P/P0) is used to convert the abscissa of an adsorption isotherm (t) to the thickness of the adsorbed layer (t). The plot obtained by plotting the adsorbed amount (V) against the thickness of the adsorbed layer (t) is called t-plot. In a t-plot, in cases where an upward shift relative to an approximate straight line passing through the origin occurs as t increases, the sample has mesopores. The total specific surface area (a1) is calculated from an approximate curve passing through the origin, and the external specific surface area (a1) is calculated from a second approximate curve. The value obtained by subtracting the external specific surface area (a2) from the total specific surface area (a1) is the pore specific surface area (a3).

In the agent for reduction of the acid value of used cooking oil, the pore specific surface area (a3) according to the t-plot method is preferably 70% or more with respect to the total specific surface area (a1). In cases where the pore specific surface area (a3) is less than 70%, infiltration of cooking oil into the cooking oil regeneration agent is insufficient, and simultaneous exertion of the deacidification effect and the decoloration effect is impossible.

The agent for reduction of the acid value of used cooking oil of the invention can be calcined at 150 to 400° C. By the calcination, the particle surface of the Mg—Al-based hydrotalcite-based compound is activated, and this allows production of a higher deacidification effect. The calcination may be carried out either in the atmosphere or under vacuum.

The agent for reduction of the acid value of used cooking oil of the invention may be subjected to granulation after the regeneration treatment in order to enable easy separation from the regenerated oil. The granulation method is not limited, and a method known as a wet granulation method may be used. Specific examples of the method include spray drying, fluidized bed granulation, tumbling granulation, mixing granulation, and extrusion granulation.

### Regeneration Treatment Method for Cooking Oil

Similarly to known deacidifying agents and decoloring agents, the agent for reduction of the acid value of used cooking oil of the invention can be used for treatment of cooking oil by bringing the agent into contact with used cooking oil at 200° C. or less. The amount of the cooking oil regeneration agent of the invention used is 0.05 to 20 parts by weight, preferably 0.1 to 10 parts by weight with respect to 100 parts by weight of cooking oil.

In the regeneration treatment method of the invention, the agent for reduction of the acid value of used cooking oil of the invention may be used in combination with a decoloring agent. By the combined use of a decoloring agent, an excellent deacidification effect and decoloration effect can be exerted at the same time. The decoloring agent may be a known decoloring agent or a commercially available product. For example, at least one of silicon oxide, acid clay, activated clay, activated carbon, and the like may be used.

Examples of the method of the contacting include, but are not limited to, the following methods.

After directly adding the agent for reduction of the acid value of used cooking oil of the invention to used cooking oil, and stirring the resulting mixture, the agent for reduction of the acid value of used cooking oil is separated from regenerated oil by filtration.

After directly adding the agent for reduction of the acid value of used cooking oil of the invention to used cooking oil, and stirring the resulting mixture, the agent for reduction of the acid value of used cooking oil is separated from regenerated oil by sedimentation.

After directly adding the agent for reduction of the acid value of used cooking oil of the invention to used cooking oil, and stirring the resulting mixture, the agent for reduction of the acid value of used cooking oil is separated from regenerated oil by centrifugation.

The agent for reduction of the acid value of used cooking oil of the invention is filled into a filter paper bag or a filter cloth bag, and the bag is then fed into used cooking oil, followed by removing the bag after a certain period of time.

A filter in which the agent for reduction of the acid value of used cooking oil of the invention is laid between filter papers or filter cloths is prepared, and used cooking oil is passed through the filter.

The cooking oil to which the agent for reduction of the acid value of used cooking oil of the invention can be applied is not limited, and examples of such cooking oil include soy oil, olive oil, rapeseed oil, sesame oil, sunflower oil, corn oil, peanut oil, rice oil, and linseed oil.

For regeneration treatment of cooking oil, calcium oxide, calcium hydroxide, calcium silicate, magnesium oxide, magnesium hydroxide, or magnesium silicate is used as a deacidifying agent. However, the reaction of the deacidifying agent with free fatty acid in the cooking oil is reaction of an acid with a solid base, that is, a neutralization reaction. In contrast, in cases where hydrotalcite is used as an agent for reduction of the acid value (=deacidifying agent), effective adsorption removal of free fatty acid is possible by using the high acidic-substance adsorption capacity of the hydrotalcite.

Free fatty acid in cooking oil reacts with an alkali metal to become a metal soap. Thus, the degree of elution of an alkali metal into cooking oil is preferably as low as possible. Since the degree of elution of magnesium ions of Mg—Al-based hydrotalcite into cooking oil is lower than the degree of elution of magnesium ions of magnesium hydroxide or magnesium oxide into cooking oil, production of a metal soap in cooking oil can be suppressed.

The content of the invention is described below in more detail by way of Examples and Comparative Examples. However, the invention is not limited to these Examples.

### EXAMPLES

1. In the Examples and the Comparative Examples, agents for reduction of the acid value of used cooking oil of the invention, and other deacidifying agents and decoloring agents, were analyzed by the following methods.

(1) Molar ratio (MgO/Al₂O₃): X-ray fluorescence analyzer RIX2000, manufactured by Rigaku Corporation

(2) BET specific surface area, pore volume: high-precision specific surface area/pore distribution measuring apparatus BELSORP-max, manufactured by MicrotracBEL Corp.

(3) X-ray structure analysis: all-in-one X-ray diffractometer EMPYREAN, manufactured by PANalytical

2. In the deacidification tests in Examples and Comparative Examples, the acid value was evaluated by the following method, and the amount of eluted magnesium ions was measured by the following method.

(1) Acid value: Evaluation is carried out using a test strip for thermal degradation of frying oils, manufactured by ADVANTEC, or according to JISK0070-1992. More specifically, regenerated oil is dissolved in diethyl ether/ethanol mixture (1:1), and phenolphthalein is added thereto as an indicator, followed by performing titration with a potassium hydroxide ethanol solution to determine the acid value.

(2) Amount of eluted magnesium ions: ICP emission spectrophotometer SPS3500DD, manufactured by Hitachi High-Tech Science Corporation

(3) Yellowness: Colorimetric color difference meter ZE-2000, manufactured by Nippon Denshoku Industries Co., Ltd.

3. The agents for reduction of the acid value of used cooking oil and the cooking oil regeneration agents used in Examples and Comparative Examples, and the measurement results are shown in Tables 1 and 2.

### Example 1

As an agent for reduction of the acid value of used cooking oil, a Mg—Al-based hydrotalcite-based compound “KYOWAAD 500SH”, manufactured by Kyowa Chemical Industry Co., Ltd., was used for cooking oil regeneration.

The molar ratio (MgO/Al₂O₃) was 5.94; the BET specific surface area was 101.6 m²/g; and the pore volume was 0.779 cm³/g.

Deacidification Test 1) To rapeseed cooking oil heated to 120° C. (evaluated acid value: 2.5), the agent for reduction of the acid value of used cooking oil was added at 5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 0 to 0.5. The filtered regenerated oil was carbonized, and the resulting residue was dissolved in dilute hydrochloric acid, followed by quantification of magnesium ions eluted into the oil, by ICP. As a result, the amount was found to be 23.4 ppm.

Deacidification Test 2) To rapeseed cooking oil heated to 120° C. (evaluated acid value: 4.0), the agent for reduction of the acid value of used cooking oil was added at 5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 0.5 to 1.0.

### Example 2

As an agent for reduction of the acid value of used cooking oil, a Mg—Al-based hydrotalcite-based compound “KYOWAAD 1000”, manufactured by Kyowa Chemical Industry Co., Ltd., was used for cooking oil regeneration.

The molar ratio (MgO/Al₂O₃) was 4.6; the BET specific surface area was 111.8 m²/g; and the pore volume was 0.876 cm³/g.

Deacidification Test 1) To rapeseed cooking oil heated to 120° C. (evaluated acid value: 2.5), the agent for reduction of the acid value of used cooking oil was added at 5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 0 to 0.5.

Deacidification Test 2) To rapeseed cooking oil heated to 120° C. (evaluated acid value: 4.0), the agent for reduction of the acid value of used cooking oil was added at 5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 0.5 to 1.0.

### Example 3

As an agent for reduction of the acid value of used cooking oil, a Mg—Al-based hydrotalcite-based compound “KYOWAAD 300SN”, manufactured by Kyowa Chemical Industry Co., Ltd., was used for cooking oil regeneration.

The molar ratio (MgO/Al₂O₃) was 2.58; the BET specific surface area was 240.7 m²/g; and the pore volume was 0.882 cm³/g.

Deacidification Test 1) To rapeseed cooking oil heated to 120° C. (evaluated acid value: 2.5), the agent for reduction of the acid value of used cooking oil was added at 5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 0.5.

Deacidification Test 2) To rapeseed cooking oil heated to 120° C. (evaluated acid value: 4.0), the agent for reduction of the acid value of used cooking oil was added at 5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 1.0.

### Comparative Example 1

As a cooking oil regeneration agent, magnesium hydroxide “KISUMA F”, manufactured by Kyowa Chemical Industry Co., Ltd., was used.

The BET specific surface area was 53.9 m²/g, and the pore volume was 0.363 cm³/g.

Deacidification Test 1) To rapeseed cooking oil heated to 120° C. (evaluated acid value: 2.5), the cooking oil regeneration agent was added at 5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 1.0. The filtered regenerated oil was carbonized, and the resulting residue was dissolved in dilute hydrochloric acid, followed by quantification of magnesium ions eluted into the oil, by ICP. As a result, the amount was found to be 55.2 ppm.

Deacidification Test 2) To rapeseed cooking oil heated to 120° C. (evaluated acid value: 4.0), the cooking oil regeneration agent was added at 5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 2.0.

### Comparative Example 2

As a cooking oil regeneration agent, magnesium silicate “KYOWAAD 600S”, manufactured by Kyowa Chemical Industry Co., Ltd., was used.

The BET specific surface area was 154.8 m²/g, and the pore volume was 0.252 cm³/g.

Deacidification Test 1) To rapeseed cooking oil heated to 120° C. (evaluated acid value: 2.5), the cooking oil regeneration agent was added at 5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 2.0.

Deacidification Test 2) To rapeseed cooking oil heated to 120° C. (evaluated acid value: 4.0), the cooking oil regeneration agent was added at 5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 3.0.

### Comparative Example 3

As a cooking oil regeneration agent, aluminum hydroxide “KYOWAAD 200S”, manufactured by Kyowa Chemical Industry Co., Ltd., was used.

The BET specific surface area was 143.2 m²/g, and the pore volume was 0.492 cm³/g.

Deacidification Test 1) To rapeseed cooking oil heated to 120° C. (evaluated acid value: 2.5), the cooking oil regeneration agent was added at 5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 0.5.

Deacidification Test 2) To rapeseed cooking oil heated to 120° C. (evaluated acid value: 4.0), the cooking oil regeneration agent was added at 5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 2.5.

### Example 4

As an agent for reduction of the acid value of used cooking oil, a Mg—Al-based hydrotalcite-based compound “KYOWAAD 500SH”, manufactured by Kyowa Chemical Industry Co., Ltd., was used for cooking oil regeneration.

The molar ratio (MgO/Al₂O₃) was 5.94; the BET specific surface area was 101.6 m²/g; and the pore volume was 0.779 cm³/g.

Deacidification Test) To rapeseed cooking oil heated to 120° C. (evaluated acid value: 4.0), the agent for reduction of the acid value of used cooking oil was added at 2.5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 1.0.

### Example 5

As an agent for reduction of the acid value of used cooking oil, a Mg—Al-based hydrotalcite-based compound “KYOWAAD 1000”, manufactured by Kyowa Chemical Industry Co., Ltd., was used for cooking oil regeneration.

The molar ratio (MgO/Al₂O₃) was 4.6; the BET specific surface area was 111.8 m²/g; and the pore volume was 0.876 cm³/g.

Deacidification Test) To rapeseed cooking oil heated to 120° C. (evaluated acid value: 4.0), the agent for reduction of the acid value of used cooking oil was added at 2.5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 0.5 to 1.0.

### Comparative Example 4

As a cooking oil regeneration agent, magnesium hydroxide “KISUMA F”, manufactured by Kyowa Chemical Industry Co., Ltd., was used.

The BET specific surface area was 53.9 m²/g, and the pore volume was 0.363 cm³/g.

Deacidification Test) To rapeseed cooking oil heated to 120° C. (evaluated acid value: 4.0), the cooking oil regeneration agent was added at 2.5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 3.5.

### Comparative Example 5

As a cooking oil regeneration agent, magnesium silicate “KYOWAAD 600S”, manufactured by Kyowa Chemical Industry Co., Ltd., was used.

The BET specific surface area was 154.8 m²/g, and the pore volume was 0.252 cm³/g.

Deacidification Test) To rapeseed cooking oil heated to 120° C. (evaluated acid value: 4.0), the cooking oil regeneration agent was added at 2.5 wt %, and the resulting mixture was stirred under heat for 30 minutes, followed by leaving the mixture to stand at room temperature for 10 minutes and then performing filtration. According to evaluation of the color of the test strip for thermal degradation of frying oils AV-CHECK, the acid value of the filtered regenerated oil was found to be 4.0.

### Example 6

As an agent for reduction of the acid value of used cooking oil, a Mg—Al-based hydrotalcite-based compound “KYOWAAD 500SH”, manufactured by Kyowa Chemical Industry Co., Ltd., was used for cooking oil regeneration.

The molar ratio (MgO/Al₂O₃) was 5.94; the BET specific surface area was 93.7 m²/g; the pore volume was 0.779 cm³/g; the total specific surface area according to the t-plot method was 78.5 m²/g; the pore specific surface area according to the t-plot method was 38 m²/g; and the pore specific surface area/the total specific surface area according to the t-plot method was 48%.

Deacidification Test 1) To rapeseed cooking oil heated to 120° C. (acid value: 4.164), a hydrotalcite “KYOWAAD 500SH” (BET specific surface area, 93.7 m²/g; total specific surface area according to the t-plot method, 78.5 m²/g; pore specific surface area according to the t-plot method, 38 m²/g; pore specific surface area/total specific surface area according to the t-plot method, 48%), manufactured by Kyowa Chemical Industry Co., Ltd., was added at 5 wt %, and the resulting mixture was stirred under heat for 30 minutes, followed by leaving the mixture to stand at room temperature for 10 minutes and then performing filtration. The acid value of the filtered regenerated oil was measured. As a result, the acid value was found to be 1.228.

Deacidification Test 2) To rapeseed cooking oil heated to 120° C. (acid value: 3.049), the “KYOWAAD 500SH” was added at 5 wt %, and the resulting mixture was stirred under heat for 30 minutes, followed by leaving the mixture to stand at room temperature for 10 minutes and then performing filtration. The acid value of the filtered regenerated oil was measured. As a result, the acid value was found to be 0.822.

Decoloration Test 1) To used rapeseed cooking oil heated to 120° C. (yellowness: 99.34), the “KYOWAAD 500SH” was added at 5 wt %, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 106.05.

Decoloration Test 2) To used rapeseed cooking oil heated to 120° C. (yellowness: 120.61), the “KYOWAAD 500SH” was added at 5 wt %, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 107.31.

### Comparative Example 6

As cooking oil regeneration agents, a Mg—Al-based hydrotalcite-based compound “KYOWAAD 500SH”, manufactured by Kyowa Chemical Industry Co., Ltd., and a silica “MIZUKASIL”, manufactured by Mizusawa Industrial Chemicals, Ltd., were used.

Deacidification Test) To rapeseed cooking oil heated to 120° C. (acid value: 4.164), the Mg—Al-based hydrotalcite-based compound “KYOWAAD 500SH”, manufactured by Kyowa Chemical Industry Co., Ltd., and the silica “MIZUKASIL”, manufactured by Mizusawa Industrial Chemicals, Ltd., were added at 3.5 wt % and 1.5 wt %, respectively, and the resulting mixture was stirred under heat for 30 minutes, followed by leaving the mixture to stand at room temperature for 10 minutes and then performing filtration. The acid value of the filtered regenerated oil was measured. As a result, the acid value was found to be 1.36.

Decoloration Test) To used rapeseed cooking oil heated to 120° C. (yellowness: 99.34), the “KYOWAAD 500SH” and the “MIZUKASIL” were added at 3.5 wt % and 1.5 wt %, respectively, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 70.51.

### Example 7

Production Method) An aqueous magnesium chloride solution and an aqueous aluminum sulfate solution are mixed together to prepare a mixture in which the molar ratio (MgO/Al₂O₃) is 4, to provide Solution A. An aqueous sodium hydroxide solution and an aqueous sodium carbonate solution are mixed together to provide Solution B. By pouring Solution A and Solution B at the same time at 30° C. with stirring, coprecipitation was allowed to proceed. The reaction pH in this process was 8.5. The obtained coprecipitate was dehydrated and washed with water to obtain a Mg—Al-based hydrotalcite-based compound.

To a suspension of the Mg—Al-based hydrotalcite-based compound, 1.0 equivalent of No. 3 water glass was added, and the resulting mixture was stirred under heat at 45° C. for 2 hours, to obtain a silica-supported hydrotalcite-based compound.

The obtained silica-supported hydrotalcite-based compound is referred to as an agent for reduction of the acid value of used cooking oil (a). In the agent for reduction of the acid value of used cooking oil (a), the specific surface area according to the BET method was 260.9 m²/g; the total specific surface area according to the t-plot method was 296.4 m²/g; the pore specific surface area according to the t-plot method was 195.22 m²/g; and the pore specific surface area/the total specific surface area according to the t-plot method was 72%. In X-ray diffraction, the peak for the (003) face was 2θ=10.7°.

Deacidification Test) To rapeseed cooking oil heated to 120° C. (acid value: 4.164), the agent for reduction of the acid value of used cooking oil (a) was added at 5 wt %, and the resulting mixture was stirred under heat for 30 minutes, followed by leaving the mixture to stand at room temperature for 10 minutes and then performing filtration. The acid value of the filtered regenerated oil was measured. As a result, the acid value was found to be 0.9.

Decoloration Test) To used rapeseed cooking oil heated to 120° C. (yellowness: 99.34), the agent for reduction of the acid value of used cooking oil (a) was added at 5 wt %, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 82.

### Example 8

Production Method) An aqueous magnesium chloride solution and an aqueous aluminum sulfate solution are mixed together to prepare a mixture in which the molar ratio (MgO/Al₂O₃) is 4, to provide Solution A. An aqueous sodium hydroxide solution and an aqueous sodium carbonate solution are mixed together to provide Solution B. By pouring Solution A and Solution B at the same time at 30° C. with stirring, coprecipitation was allowed to proceed. The reaction pH in this process was 8.5. The obtained coprecipitate was dehydrated and washed with water to obtain a Mg—Al-based hydrotalcite-based compound.

To a suspension of the Mg—Al-based hydrotalcite-based compound, 2.0 equivalents of No. 3 water glass was added, and the resulting mixture was stirred under heat at 45° C. for 2 hours, to obtain a silica-supported hydrotalcite-based compound.

The obtained silica-supported hydrotalcite-based compound is referred to as an agent for reduction of the acid value of used cooking oil (b). In the agent for reduction of the acid value of used cooking oil (b), the specific surface area according to the BET method was 193 m²/g; the total specific surface area according to the t-plot method was 223.6 m²/g; the pore specific surface area according to the t-plot method was 160.2 m²/g; and the pore specific surface area/the total specific surface area according to the t-plot method was 72%.

Deacidification Test) To rapeseed cooking oil heated to 120° C. (acid value: 4.164), the agent for reduction of the acid value of used cooking oil (b) was added at 5 wt %, and the resulting mixture was stirred under heat for 30 minutes, followed by leaving the mixture to stand at room temperature for 10 minutes and then performing filtration. The acid value of the filtered regenerated oil was measured. As a result, the acid value was found to be 1.1.

Decoloration Test) To used rapeseed cooking oil heated to 120° C. (yellowness: 99.34), the agent for reduction of the acid value of used cooking oil (b) was added at 5 wt %, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 79.

### Example 9

Production Method) An aqueous magnesium chloride solution and an aqueous aluminum sulfate solution are mixed together to prepare a mixture in which the molar ratio (MgO/Al₂O₃) is 6, to provide Solution A. An aqueous sodium hydroxide solution and an aqueous sodium carbonate solution are mixed together to provide Solution B. By pouring Solution A and Solution B at the same time at 30° C. with stirring, coprecipitation was allowed to proceed. The reaction pH in this process was 8.83. The obtained coprecipitate was dehydrated and washed with water to obtain a Mg—Al-based hydrotalcite-based compound.

To a suspension of the Mg—Al-based hydrotalcite-based compound, 1.2 equivalents of No. 3 water glass was added, and the resulting mixture was stirred under heat at 45° C. for 2 hours, to obtain a silica-supported hydrotalcite-based compound.

The obtained silica-supported hydrotalcite-based compound is referred to as an agent for reduction of the acid value of used cooking oil (c). In the agent for reduction of the acid value of used cooking oil (c), the specific surface area according to the BET method was 235.3 m²/g; the total specific surface area according to the t-plot method was 297 m²/g; the pore specific surface area according to the t-plot method was 217.2 m²/g; and the pore specific surface area/the total specific surface area according to the t-plot method was 73%.

Deacidification Test 1) To rapeseed cooking oil heated to 120° C. (acid value: 4.164), the agent for reduction of the acid value of used cooking oil (c) was added at 5 wt %, and the resulting mixture was stirred under heat for 30 minutes, followed by leaving the mixture to stand at room temperature for 10 minutes and then performing filtration. The acid value of the filtered regenerated oil was measured. As a result, the acid value was found to be 0.837.

Deacidification Test 2) To rapeseed cooking oil heated to 120° C. (acid value: 3.049), the agent for reduction of the acid value of used cooking oil (c) was added at 5 wt %, and the resulting mixture was stirred under heat for 30 minutes, followed by leaving the mixture to stand at room temperature for 10 minutes and then performing filtration. The acid value of the filtered regenerated oil was measured. As a result, the acid value was found to be 0.67.

Decoloration Test 1) To used rapeseed cooking oil heated to 120° C. (yellowness: 99.34), the agent for reduction of the acid value of used cooking oil (c) was added at 5 wt %, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 83.94.

Decoloration Test 2) To used rapeseed cooking oil heated to 120° C. (yellowness: 120.61), the agent for reduction of the acid value of used cooking oil (c) was added at 5 wt %, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 86.19.

### Example 10

Production Method) An aqueous magnesium chloride solution and an aqueous aluminum sulfate solution are mixed together to prepare a mixture in which the molar ratio (MgO/Al₂O₃) is 6, to provide Solution A. An aqueous sodium hydroxide solution and an aqueous sodium carbonate solution are mixed together to provide Solution B. By pouring Solution A and Solution B at the same time at 30° C. with stirring, coprecipitation was allowed to proceed. The reaction pH in this process was 8.83. The obtained coprecipitate was dehydrated and washed with water to obtain a Mg—Al-based hydrotalcite-based compound.

To a suspension of the Mg—Al-based hydrotalcite-based compound, 1.2 equivalents of No. 3 water glass was added, and the resulting mixture was stirred under heat at 90° C. for 2 hours, to obtain a silica-supported hydrotalcite-based compound.

The obtained silica-supported hydrotalcite-based compound is referred to as an agent for reduction of the acid value of used cooking oil (d). In the agent for reduction of the acid value of used cooking oil (d), the specific surface area according to the BET method was 241.9 m²/g; the total specific surface area according to the t-plot method was 300.7 m²/g; the pore specific surface area according to the t-plot method was 223.8 m²/g; and the pore specific surface area/the total specific surface area according to the t-plot method was 74%.

Deacidification Test 1) To rapeseed cooking oil heated to 120° C. (acid value: 4.164), the agent for reduction of the acid value of used cooking oil (d) was added at 5 wt %, and the resulting mixture was stirred under heat for 30 minutes, followed by leaving the mixture to stand at room temperature for 10 minutes and then performing filtration. The acid value of the filtered regenerated oil was measured. As a result, the acid value was found to be 1.248.

Deacidification Test 2) To rapeseed cooking oil heated to 120° C. (acid value: 3.049), the agent for reduction of the acid value of used cooking oil (d) was added at 5 wt %, and the resulting mixture was stirred under heat for 30 minutes, followed by leaving the mixture to stand at room temperature for 10 minutes and then performing filtration. The acid value of the filtered regenerated oil was measured. As a result, the acid value was found to be 0.854.

Decoloration Test 1) To used rapeseed cooking oil heated to 120° C. (yellowness: 99.34), the agent for reduction of the acid value of used cooking oil (d) was added at 5 wt %, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 82.21.

Decoloration Test 2) To used rapeseed cooking oil heated to 120° C. (yellowness: 120.61), the agent for reduction of the acid value of used cooking oil (d) was added at 5 wt %, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 81.89.

### Example 11

Production Method) An aqueous magnesium chloride solution and an aqueous aluminum sulfate solution are mixed together to prepare a mixture in which the molar ratio (MgO/Al₂O₃) is 8, to provide Solution A. An aqueous sodium hydroxide solution and an aqueous sodium carbonate solution are mixed together to provide Solution B. By pouring Solution A and Solution B at the same time at 30° C. with stirring, coprecipitation was allowed to proceed. The reaction pH in this process was 9.03. The obtained coprecipitate was dehydrated and washed with water to obtain a Mg—Al-based hydrotalcite-based compound.

To a suspension of the Mg—Al-based hydrotalcite-based compound, 1.2 equivalents of No. 3 water glass was added, and the resulting mixture was stirred under heat at 45° C. for 2 hours, to obtain a silica-supported hydrotalcite-based compound.

The obtained silica-supported hydrotalcite-based compound is referred to as an agent for reduction of the acid value of used cooking oil (e). In the agent for reduction of the acid value of used cooking oil (e), the specific surface area according to the BET method was 204.7 m²/g; the total specific surface area according to the t-plot method was 252.7 m²/g; the pore specific surface area according to the t-plot method was 180.7 m²/g; and the pore specific surface area/the total specific surface area according to the t-plot method was 72%.

Deacidification Test) To rapeseed cooking oil heated to 120° C. (acid value: 4.164), the agent for reduction of the acid value of used cooking oil (e) was added at 5 wt %, and the resulting mixture was stirred under heat for 30 minutes, followed by leaving the mixture to stand at room temperature for 10 minutes and then performing filtration. The acid value of the filtered regenerated oil was measured. As a result, the acid value was found to be 0.859.

Decoloration Test) To used rapeseed cooking oil heated to 120° C. (yellowness: 99.34), the agent for reduction of the acid value of used cooking oil (e) was added at 5 wt %, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 81.65.

### Example 12

Production Method) An aqueous magnesium chloride solution and an aqueous aluminum sulfate solution are mixed together to prepare a mixture in which the molar ratio (MgO/Al₂O₃) is 8, to provide Solution A. An aqueous sodium hydroxide solution and an aqueous sodium carbonate solution are mixed together to provide Solution B. By pouring Solution A and Solution B at the same time at 30° C. with stirring, coprecipitation was allowed to proceed. The reaction pH in this process was 9.03. The obtained coprecipitate was dehydrated and washed with water to obtain a Mg—Al-based hydrotalcite-based compound.

To a suspension of the Mg—Al-based hydrotalcite-based compound, 1.2 equivalents of No. 3 water glass was added, and the resulting mixture was stirred under heat at 90° C. for 2 hours, to obtain a silica-supported hydrotalcite-based compound.

The obtained silica-supported hydrotalcite-based compound is referred to as an agent for reduction of the acid value of used cooking oil (f). In the agent for reduction of the acid value of used cooking oil (f), the specific surface area according to the BET method was 220.3 m²/g; the total specific surface area according to the t-plot method was 277.1 m²/g; the pore specific surface area according to the t-plot method was 203.4 m²/g; and the pore specific surface area/the total specific surface area according to the t-plot method was 73%.

Deacidification Test) To rapeseed cooking oil heated to 120° C. (acid value: 4.164), the agent for reduction of the acid value of used cooking oil (f) was added at 5 wt %, and the resulting mixture was stirred under heat for 30 minutes, followed by leaving the mixture to stand at room temperature for 10 minutes and then performing filtration. The acid value of the filtered regenerated oil was measured. As a result, the acid value was found to be 1.175.

Decoloration Test) To used rapeseed cooking oil heated to 120° C. (yellowness: 99.34), the agent for reduction of the acid value of used cooking oil (f) was added at 5 wt %, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 76.62.

### Comparative Example 7

Production Method) To 300 parts by weight of ion-exchanged water, 70 parts by weight of a Mg—Al-based hydrotalcite-based compound “KYOWAAD 500SH”, manufactured by Kyowa Chemical Industry Co., Ltd., and 30 parts by weight of a silica “MIZUKASIL”, manufactured by Mizusawa Industrial Chemicals, Ltd., were added, and the resulting mixture was stirred under heat at 90° C. for 30 minutes, followed by filtration and drying. The obtained wet mixture of the hydrotalcite and the silica is referred to as a cooking oil regeneration agent (g). In the cooking oil regeneration agent (g), the specific surface area according to the BET method was 161.9 m²/g; the total specific surface area according to the t-plot method was 195.1 m²/g; the pore specific surface area according to the t-plot method was 113.7 m²/g; and the pore specific surface area/the total specific surface area according to the t-plot method was 58%. X-ray diffraction showed a peak similar to that of the hydrotalcite “KYOWAAD 500SH”, wherein 2θ=11.2°.

Deacidification Test 1) To rapeseed cooking oil heated to 120° C. (acid value: 4.164), the cooking oil regeneration agent (g) was added at 5 wt %, and the resulting mixture was stirred under heat for 30 minutes, followed by leaving the mixture to stand at room temperature for 10 minutes and then performing filtration. The acid value of the filtered regenerated oil was measured. As a result, the acid value was found to be 1.423.

Deacidification Test 2) To rapeseed cooking oil heated to 120° C. (acid value: 3.049), the cooking oil regeneration agent (g) was added at 5 wt %, and the resulting mixture was stirred under heat for 30 minutes, followed by leaving the mixture to stand at room temperature for 10 minutes and then performing filtration. The acid value of the filtered regenerated oil was measured. As a result, the acid value was found to be 1.12.

Decoloration Test 1) To used rapeseed cooking oil heated to 120° C. (yellowness: 99.34), the cooking oil regeneration agent (g) was added at 5 wt %, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 79.66.

Decoloration Test 2) To used rapeseed cooking oil heated to 120° C. (yellowness: 120.61), the cooking oil regeneration agent (g) was added at 5 wt %, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 86.92.

### Comparative Example 8

Production Method) In 300 parts by weight of ion-exchanged water, 70 parts by weight of a hydrotalcite-based compound “KYOWAAD 500SH”, manufactured by Kyowa Chemical Industry Co., Ltd., was suspended, and an equivalent of No. 3 water glass was added thereto, followed by stirring the resulting mixture under heat at 90° C. for 30 minutes. Thereafter, filtration was carried out under reduced pressure, and then the mixture was dried. The obtained wet mixture of the hydrotalcite and the No. 3 water glass is referred to as a cooking oil regeneration agent (h). In the cooking oil regeneration agent (h), the specific surface area according to the BET method was 145.7 m²/g; the total specific surface area according to the t-plot method was 187.1 m²/g; the pore specific surface area according to the t-plot method was 98.5 m²/g; and the pore specific surface area/the total specific surface area according to the t-plot method was 53%. X-ray diffraction showed a peak similar to that of the hydrotalcite “KYOWAAD 500SH”.

Deacidification Test) To rapeseed cooking oil heated to 120° C. (acid value: 4.164), the cooking oil regeneration agent (h) was added at 5 wt %, and the resulting mixture was stirred under heat for 30 minutes, followed by leaving the mixture to stand at room temperature for 10 minutes and then performing filtration. The acid value of the filtered regenerated oil was measured. As a result, the acid value was found to be 1.86.

Decoloration Test) To used rapeseed cooking oil heated to 120° C. (yellowness: 99.34), the cooking oil regeneration agent (h) was added at 5 wt %, and the resulting mixture was stirred under heat for 30 minutes, followed by leaving the mixture to stand at room temperature for 10 minutes and then performing filtration. The yellowness of the filtered regenerated oil was measured. As a result, the yellowness was found to be 96.27.

TABLE 1

| | | | | | Comparative | Comparative | Comparative |
|---|---|---|---|---|---|---|---|
| | | Example 1 | Example 2 | Example 3 | Example 1 | Example 2 | Example 3 |
| KYOWAAD 500SH | wt % | 5 | | | | | |
| KYOWAAD 1000 | wt % | | 5 | | | | |
| KYOWAAD 300SN | wt % | | | 5 | | | |
| KISUMA F | wt % | | | | 5 | | |
| KYOWAAD 600S | wt % | | | | | 5 | |
| KYOWAAD 200S | wt % | | | | | | 5 |
| BET specific surface area | m²/g | 97.0 | 111.8 | 240.7 | 53.9 | 154.8 | 143.2 |
| Pore volume | cm³/g | 0.778 | 0.876 | 0.882 | 0.363 | 0.252 | 0.492 |

| | | | | | | |
|---|---|---|---|---|---|---|
| Deacidification test (acid | 0 to 0.5 | 0 to 0.5 | 0.5 | 1.0 | 2.0 | 0.5 |
| value before treatment: 2.5) | | | | | | |
| Deacidification test (acid | 0.5 to 1.0 | 0.5 to 1.0 | 1.0 | 2.0 | 3.0 | 2.5 |
| value before treatment: 4.0) | | | | | | |

| | | | | Comparative | Comparative |
|---|---|---|---|---|---|
| | | Example 4 | Example 5 | Example 4 | Example 5 |
| KYOWAAD 500SH | wt % | 2.5 | | | |
| KYOWAAD 1000 | wt % | | 2.5 | | |
| KYOWAAD 300SN | wt % | | | | |
| KISUMA F | wt % | | | 2.5 | |
| KYOWAAD 600S | wt % | | | | 2.5 |
| KYOWAAD 200S | wt % | | | | |
| BET specific surface area | m²/g | 97.0 | 111.8 | 53.9 | 154.8 |
| Pore volume | cm³/g | 0.778 | 0.876 | 0.363 | 0.252 |

| | | | | |
|---|---|---|---|---|
| Deacidification test (acid | — | — | — | — |
| value before treatment: 2.5) | | | | |
| Deacidification test (acid | 1.0 | 0.5 to 1.0 | 3.5 | 4 |
| value before treatment: 4.0) | | | | |

TABLE 2

| | | | | Comparative | | | | |
|---|---|---|---|---|---|---|---|---|
| | | | Example 6 | Example 6 | Example 7 | Example 8 | Example 9 | Example 10 |
| KYOWAAD 500SH | | wt % | 5 | 3.5 | | | | |
| Agent for reduction of acid value (a) | | wt % | | | 5 | | | |
| Agent for reduction of acid value (b) | | wt % | | | | 5 | | |
| Agent for reduction of acid value (c) | | wt % | | | | | 5 | |
| Agent for reduction of acid value (d) | | wt % | | | | | | 5 |
| Agent for reduction of acid value (e) | | wt % | | | | | | |
| Agent for reduction of acid value (f) | | wt % | | | | | | |
| Cooking oil regeneration agent (g) | | wt % | | | | | | |
| Cooking oil regeneration agent (h) | | wt % | | | | | | |
| MIZUKASIL | | wt % | | 1.5 | | | | |
| BET method | Specific surface area | m²/g | 93.7 | — | 260.9 | 193.0 | 235.3 | 241.9 |
| t-Plot method | Total specific surface area | m²/g | 78.5 | — | 296.4 | 223.6 | 297 | 300.7 |
| | Pore specific surface area | m²/g | 38 | — | 195.2 | 160.2 | 217.2 | 223.8 |

| | | | | | | | |
|---|---|---|---|---|---|---|---|
| Pore specific surface area/total | % | 48 | — | 72 | 72 | 73 | 74 |
| specific surface area | | | | | | | |

| | | | | | | |
|---|---|---|---|---|---|---|
| Deacidification test (acid value | 1.228 | 1.36 | 0.9 | 1.1 | 0.837 | 1.248 |
| before treatment: 4.164) | | | | | | |
| Deacidification test (acid value | 0.822 | | | | 0.67 | 0.854 |
| before treatment: 3.049) | | | | | | |
| Decoloration Test (yellowness | 106.05 | 70.51 | 82 | 79 | 83.94 | 82.21 |
| before treatment: 99.34) | | | | | | |
| Decoloration Test (yellowness | 107.31 | | | | 86.19 | 81.89 |
| before treatment: 120.61) | | | | | | |

| | | | | | Comparative | Comparative |
|---|---|---|---|---|---|---|
| | | | Example 11 | Example 12 | Example 8 | Example 9 |
| KYOWAAD 500SH | | wt % | 2.5 | | | |
| Agent for reduction of acid value (a) | | wt % | | | | |
| Agent for reduction of acid value (b) | | wt % | | | | |
| Agent for reduction of acid value (c) | | wt % | | | | |
| Agent for reduction of acid value (d) | | wt % | | | | |
| Agent for reduction of acid value (e) | | wt % | 5 | | | |
| Agent for reduction of acid value (f) | | wt % | | 5 | | |
| Cooking oil regeneration agent (g) | | wt % | | | 5 | |
| Cooking oil regeneration agent (h) | | wt % | | | | 5 |
| MIZUKASIL | | wt % | | | | |
| BET method | Specific surface area | m²/g | 204.7 | 220.3 | 161.9 | 145.7 |
| t-Plot method | Total specific surface area | m²/g | 252.7 | 277. | 195.9 | 187.1 |
| | Pore specific surface area | m²/g | 180.7 | 203.4 | 113.7 | 98.5 |

| | | | | | |
|---|---|---|---|---|---|
| Pore specific surface area/total | % | 72 | 73 | 58 | 53 |
| specific surface area | | | | | |

| | | | | |
|---|---|---|---|---|
| Deacidification test (acid value | 0.859 | 1.175 | 1.423 | 1.504 |
| before treatment: 4.164) | | | | |
| Deacidification test (acid value | | | 1.12 | |
| before treatment: 3.049) | | | | |
| Decoloration Test (yellowness | 81.65 | 76.62 | 79.66 | 96.01 |
| before treatment: 99.34) | | | | |
| Decoloration Test (yellowness | | | 86.92 | |
| before treatment: 120.61) | | | | |

### INDUSTRIAL APPLICABILITY

As described above, the cooking oil regeneration agent of the invention has an excellent deacidification effect, or has both an excellent deacidification effect and an excellent decoloration effect. Therefore, a cooking oil subjected to regeneration treatment using the agent has a sufficiently satisfactory taste, color, and flavor, and allows cooking of fried foods with sufficiently satisfactory qualities. Thus, the agent can extend the life of cooking oil, and can significantly reduce the amount of waste oil not only when it is used at home, but also when it is used in a store or a factory where a large amount of cooking oil is used. Therefore, the agent can contribute to reduction of the cost of fried foods and reduction of a cause of environmental pollution.

1-12. (canceled)

13. An agent for reduction of the acid value of used cooking oil, the agent comprising a hydrotalcite-related compound as an effective component, wherein the agent has a deacidification capacity that reduces the acid value by 70% or more, and has a decoloration capacity that reduces yellowness due to deterioration by 15%,
characterized in that the hydrotalcite-related compound is a silica-supported Mg—Al-based hydrotalcite-based compound in which silica is supported in the interlayer or on the surface of a Mg—Al-based hydrotalcite-based compound; the molar ratio (MgO/Al₂O₃) is 4 to 8; in X-ray diffraction, the peak for the (003) face of the silica-supported hydrotalcite-based compound is shifted toward the low-angle side relative to the peak for the (003) face of the Mg—Al-based hydrotalcite-based compound; the specific surface area according to the BET method is 150 m²/g or more; the total specific surface area according to the t-plot method is 200 m²/g or more; the pore specific surface area according to the t-plot method is 140 m²/g or more; and the pore specific surface area according to the t-plot method accounts for 70% or more of the total specific surface area.

14. The agent for reduction of the acid value of used cooking oil according to claim 13, wherein the silica-supported hydrotalcite-based compound has a specific surface area of 200 m²/g or more according to the BET method, a total specific surface area of 250 m²/g or more according to the t-plot method, and a pore specific surface area of 180 m²/g or more according to the t-plot method, wherein the pore specific surface area according to the t-plot method accounts for 70% or more of the total specific surface area.

15. The agent for reduction of the acid value of used cooking oil according to claim 14, wherein the silica-supported hydrotalcite-based compound has a specific surface area of 250 m²/g or more according to the BET method, a total specific surface area of 300 m²/g or more according to the t-plot method, and a pore specific surface area of 220 m²/g or more according to the t-plot method, wherein the pore specific surface area according to the t-plot method accounts for 70% or more of the total specific surface area.

16. The agent for reduction of the acid value of used cooking oil according to claim 13, wherein the silica-supported Mg—Al-based hydrotalcite-based compound is represented by the following Formula (2):
Mg₁₋ₓAlₓ(OH)₂(A₁ⁿ⁻)ₐ(A₂^{m-})_{b}.yH₂O (2)
[Mg₁₋ₓAlₓ(OH)₂]^{x+}[(A₁ⁿ⁻)ₐ(A₂^{m-})_{b}.yH₂O]
(wherein in the formula, A₁ⁿ⁻ represents an n-valent silicate anion, wherein the n-valent silicate anion is an anion selected from the group consisting of SiO₃²⁻, HSiO₃⁻, Si₂O₅²⁻, and HSi₂O₅⁻; A₂^{m-} represents an anion selected from the group consisting of CO₃²⁻, SO₄²⁻, NO₃⁻, Cl⁻, and OH⁻;
x and y satisfy the inequality 0.18≤x≤0.44 and the inequality 0≤y<2; and
a and b satisfy the inequality 0.28≤na+mb≤0.4).

17. The agent for reduction of the acid value of used cooking oil according to claim 14, wherein the silica-supported Mg—Al-based hydrotalcite-based compound is represented by the following Formula (2):
Mg₁₋ₓAlₓ(OH)₂(A₁ⁿ⁻)ₐ(A₂^{m-})_{b}.yH₂O (2)
[Mg₁₋ₓAlₓ(OH)₂]^{x+}[(A₁ⁿ⁻)ₐ(A₂^{m-})_{b}.yH₂O]
(wherein in the formula, A₁ⁿ⁻ represents an n-valent silicate anion, wherein the n-valent silicate anion is an anion selected from the group consisting of SiO₃²⁻, HSiO₃⁻, Si₂O₅²⁻, and HSi₂O₅⁻; A₂^{m-} represents an anion selected from the group consisting of CO₃²⁻, SO₄²⁻, NO₃⁻, Cl⁻, and OH⁻;
x and y satisfy the inequality 0.18≤x≤0.44 and the inequality 0≤y<2; and
a and b satisfy the inequality 0.28≤na+mb≤0.4).

18. The agent for reduction of the acid value of used cooking oil according to claim 13, wherein the hydrotalcite-related compound is a hydrotalcite-related compound calcined at 150 to 400° C.

19. The agent for reduction of the acid value of used cooking oil according to claim 13, wherein the hydrotalcite-related compound is a hydrotalcite-related compound granulated to have an average particle size of 50 to 200 μm.

20. The agent for reduction of the acid value of used cooking oil according to claim 13, wherein the used cooking oil is used cooking oil heated to a temperature of 200° C. or less.

21. A regeneration treatment method for used cooking oil, characterized in that the agent for reduction of the acid value of used cooking oil according to claim 13 is brought into contact with used cooking oil heated to a temperature of 200° C. or less.

22. A regeneration treatment method for used cooking oil, characterized in that the agent for reduction of the acid value of used cooking oil according to claim 14 is brought into contact with used cooking oil heated to a temperature of 200° C. or less.
